(19) United States
(12) Patent Application Publication
(10) Pub. No.: US 2024/0404392 A1
(43) Pub. Date: Dec. 5, 2024

(54) LOST REMINDER METHOD OF SMART KEY AND NON-TRANSITORY COMPUTER READABLE MEDIUM

(71) Applicants: INVENTEC (PUDONG) TECHNOLOGY CORPORATION, Shanghai (CN); INVENTEC CORPORATION, Taipei City (TW)

(72) Inventor: Haibing WEI, Shanghai (CN)

(73) Assignees: INVENTEC (PUDONG) TECHNOLOGY CORPORATION, Shanghai (CN); INVENTEC CORPORATION, Taipei City (TW)

(21) Appl. No.: 18/210,002

(22) Filed: Jun. 14, 2023

(30) Foreign Application Priority Data
Jun. 5, 2023 (CN) 202310659372.4

(51) Int. Cl. G08B 21/24; G08B 7/06; H04B 17/318

(52) U.S. Cl. CPC G08B 21/24; G08B 7/06; H04B 17/318

(57) ABSTRACT

A lost reminder method of a smart key includes performing a plurality of steps with a mobile device. The plurality of steps includes: periodically determining whether the smart key is connected to the mobile device via the Bluetooth at a preset time period, outputting a reminder message when the smart key is not connected to the mobile device via the Bluetooth, and selectively updating the preset time period according to a set instruction in response to the reminder message.

### CROSS-REFERENCE TO RELATED APPLICATIONS

This non-provisional application claims priority under 35 U.S.C. § 119 (a) on Patent Application No(s). 202310659372.4 filed in China on Jun. 5, 2023, the entire contents of which are hereby incorporated by reference.

### BACKGROUND

### 1. Technical Field

This disclosure relates to a lost reminder method, especially relates to a lost reminder method of smart key.

### 2. Related Art

Automobile smart key adopts the radio frequency technologies of the radio-frequency identification (RFID), the accurate ranging technologies of ultra-wideband (UWB) wireless carrier communications and the automobile code identification system. Automobile smart key takes the lead in the development of miniaturized and low-power RF antennas, and successfully integrates the remote control system and keyless system, follows the traditional circuit protection of the entire vehicle, truly realizes the dual RF system and dual anti-theft protection, and provides maximum convenience and safety for the owner. The development of technology has driven the renewal of the product, the entry system has changed from the original mechanical key to a remote control system, with the widely usage of RFID and UWB technologies and the demand of the automobile market, the automobile smart key is increasingly used in automobile products.

However, in order to pursue smartness and aesthetics, automobile smart keys is often removed off the mechanical key configuration and key fob function, which may lead to some problems. On one hand, if the smart key is stolen or lost, the automobile may be at risk of theft. On the other hand, if the key is accidentally forgotten or lost, the owner may have to spend a lot of time and money on reconfiguring a new key. This is an implicit and urgent need for users.

### SUMMARY

Accordingly, this disclosure provides a lost reminder method of a smart key and a non-transitory computer readable medium storing computer executable program corresponding to the method.

According to one or more embodiments of this disclosure, the lost reminder method of the smart key comprises performing a plurality of steps with a mobile device. The plurality of steps includes: periodically determining whether the smart key is connected to the mobile device via the Bluetooth at a preset time period, outputting a reminder message when the smart key is not connected to the mobile device via the Bluetooth, and selectively updating the preset time period according to a set instruction in response to the reminder message.

According to one or more embodiments of this disclosure, a non-transitory computer readable medium includes at least one computer executable program, and the at least one computer executable program is executed by a processor to carry out the lost reminder method of the smart key as described above.

In view of the above description, the lost reminder method of the smart key and the non-transitory computer readable medium storing computer executable program corresponding to the method of this disclosure may provide the user with a reminder immediately after losing the smart key, and may be used to retrieve the smart key in a smaller range and with a less time shift, thus improving the problem of time and money spent on reconfiguration when losing the smart key.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of the operating environment of a lost reminder method of a smart key according to an embodiment of the disclosure;

FIG. 2 is a flowchart illustrating a lost reminder method of a smart key according to an embodiment of the disclosure;

FIG. 3 is a flowchart illustrating the step of updating a preset time period of a lost reminder method of a smart key according to an embodiment of the disclosure;

FIG. 4 is a flowchart illustrating the step of updating the preset time period of a lost reminder method of a smart key according to another embodiment of the disclosure; and

FIG. 5 is a flowchart illustrating the step of closing option of a lost reminder method of a smart key according to yet another embodiment of the disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

Please refer to FIG. 1 which is a schematic diagram of the operating environment of a lost reminder method of a smart key according to an embodiment of the disclosure. As shown in FIG. 1, the operating environment comprises a mobile device 1 and a smart key 2, the mobile device 1 and the smart key 2 may be connected to each other via the Bluetooth.

The mobile device 1 is used to execute the lost reminder method of the smart key. For example, the mobile device 1 may be a smart phone, a tablet computer, a wearable device or other devices.

The smart key 2 is used to connect to the mobile device 1 via the Bluetooth. For example, the smart key 2 may be a smart key for car.

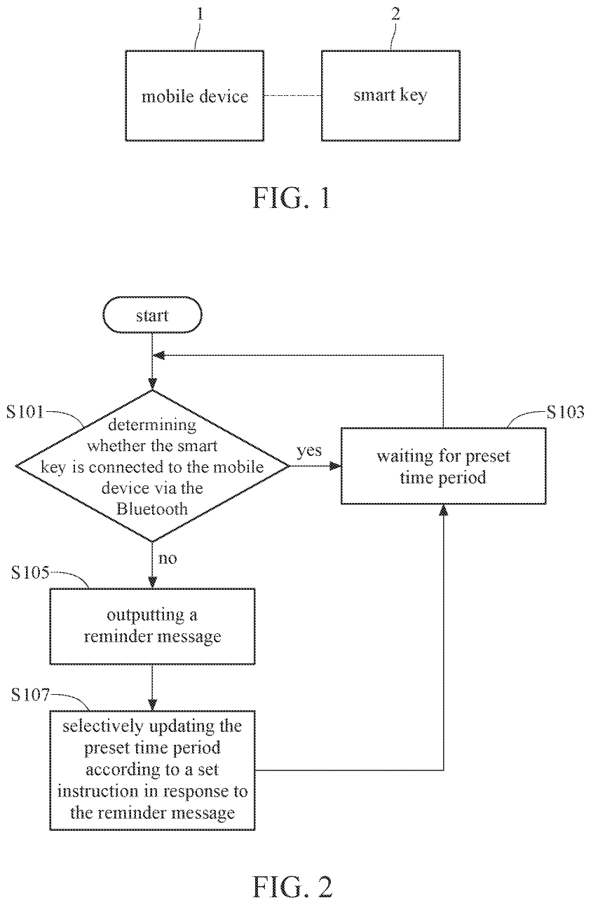

Please refer to FIG. 2 along with FIG. 1, wherein FIG. 2 is a flowchart illustrating a lost reminder method of a smart key according to an embodiment of the disclosure. As shown in FIG. 2, the lost reminder method of the smart key comprises step S101: determining whether the smart key is connected to the mobile device via the Bluetooth; when the smart key 2 is connected to the mobile device 1 via the Bluetooth, performing step S103: waiting for a preset time period; when the smart key 2 is not connected to the mobile device 1 via the Bluetooth, performing step S105: outputting a reminder message; and step S107: selectively updating the preset time period according to a set instruction in response to the reminder message. The lost reminder method of the smart key shown in FIG. 2 may be executed by the mobile device 1 shown in FIG. 1, but is not limited in the present disclosure. For better understanding, the steps of the lost reminder method of the smart key are exemplarily illustrated by the operation of the mobile device 1 in the following descriptions.

In step S101, the mobile device 1 determines whether the smart key 2 is connected to the mobile device 1 via the Bluetooth. Specifically, the mobile device 1 and the smart key 2 are connected wirelessly to each other using the built-in Bluetooth function. The mobile device 1 determines whether the smart key 2 is connected to the mobile device 1 through determining whether the mobile device 1 receives a Bluetooth signal from the smart key 2.

In step S103, the mobile device 1 waits for a preset time period without determining whether the smart key 2 is connected to the mobile device 1 via the Bluetooth. Specifically, when the mobile device 1 determines that the smart key 2 is connected to the mobile device 1 via the Bluetooth, the mobile device 1 will wait the preset time period before determining the connection status of the mobile device 1 and the smart key 2 again. That is, the mobile device 1 periodically determines whether the smart key 2 is connected to the mobile device 1 via the Bluetooth using the preset time period. For example, the preset time period may be ten seconds.

In the present embodiment, when the smart key 2 is connected to the mobile device 1 via the Bluetooth, the mobile device 1 will not output the reminder message during the preset time period of waiting. Further, when it is determined that the smart key 2 is connected to the mobile device 1 via the Bluetooth, step S103 may further comprise outputting, by the mobile device 1, a strength message corresponding to the Bluetooth signal strength. Specifically, the strength message comprises the signal strength of the Bluetooth signal from the smart key 2, and may be provided to the user to confirm the distance between the smart key 2 and the mobile device 1.

In step S105, when the smart key 2 is not connected to the mobile device 1 via the Bluetooth, the mobile device 1 outputs the reminder message. Specifically, the reminder message outputted by the mobile device 1 may comprise a text pop-up window. Further, in addition to the text pop-up window, the reminder message outputted from the mobile device 1 may further comprise at least one of a voice signal and a vibration signal.

In the present embodiment, the reminder message outputted from the mobile device 1 may comprise a notification of the loss of the smart key 2. Additionally, the reminder message may further comprise geographic information corresponding to a time point when it is determined that the smart key 2 is not connected to the mobile device 1 via the Bluetooth. In this way, even if the user fails to view the reminder message outputted on the mobile device 1 immediately, the geographic location of the smart key 2 may be deduced from the geographic information in the reminder message.

In step S107, the mobile device 1 selectively updates the preset time period according to a set instruction in response to the reminder message. Specifically, the mobile device 1 may receive the set instruction entered by the user in response to the reminder message and update the preset time period or perform no action according to this set instruction. For example, the set instruction may comprise a designated time period, the mobile device 1 may replace the current preset time period with the designated time period.

After step S107, the mobile device 1 may perform step S103, wait for the updated preset time period or the original preset time period and then perform step S101 again to determine whether the smart key 2 is connected to the mobile device 1 via the Bluetooth. That is, the connection status of the mobile device 1 and the smart key 2 is determined periodically by the updated preset time period or the original preset time period.

In view of the above description, when the mobile device 1 determines that the smart key 2 is connected to the mobile device 1 via the Bluetooth, the mobile device 1 may output the strength message corresponding to the signal strength of the Bluetooth signal. For the mobile device 1 to perform step S101 after steps S107 and S103 and the result of the determination of step S101 is that the smart key 2 is connected to the mobile device 1 via the Bluetooth, the strength message provided by the mobile device 1 may assist the user in searching for the smart key 2.

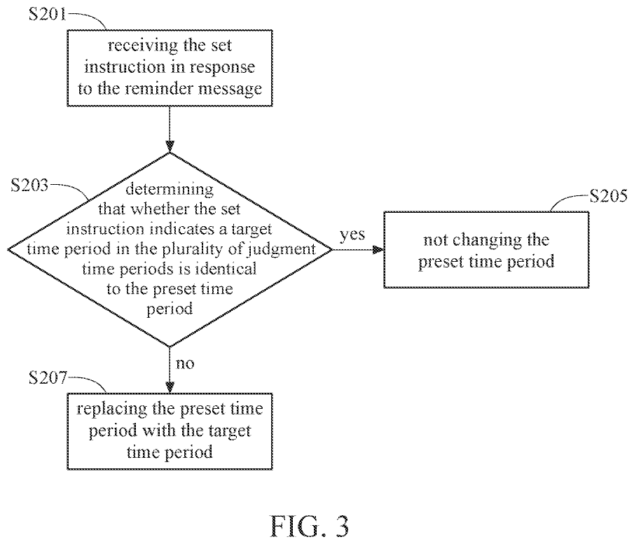

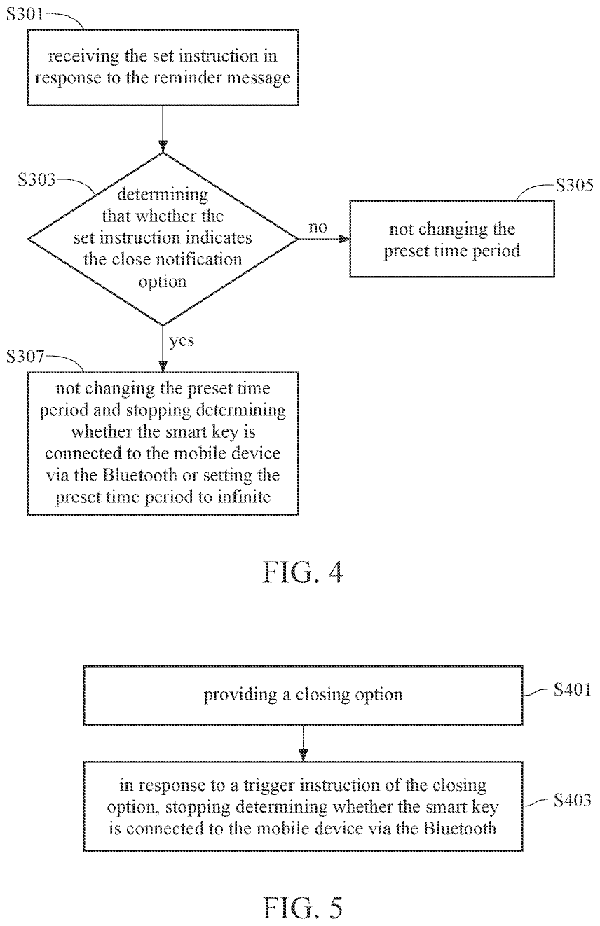

To further explain step S107, please refer to FIG. 3 and FIG. 4 along with FIG. 1 and FIG. 2, wherein FIG. 3 is a flowchart illustrating the step of updating the preset time period of a lost reminder method of a smart key according to an embodiment of the disclosure, and FIG. 4 is a flowchart illustrating the step of updating the preset time period of a lost reminder method of a smart key according to another embodiment of the disclosure.

As shown in FIG. 3, step S107 shown in FIG. 2 may comprise step S201: receiving the set instruction in response to the reminder message; step S203: determining whether a target time period in a plurality of judgment time periods indicated by the set instruction is identical to the preset time period; when the target time period in the plurality of judgment time periods indicated by the set instruction is identical to the preset time period, performing step S205: not changing the preset time period; and when the target time period in the plurality of judgment time periods indicated by the set instruction is different from the preset time period, performing step S207: replacing the preset time period with the target time period.

In step S201, the mobile device 1 receive the set instruction in response to the reminder message. Specifically, the set instruction received by the mobile device 1 is in response to the reminder message, wherein the reminder message may comprise a plurality of options corresponding to a plurality of judgment time periods respectively. For example, the plurality of options corresponding to the plurality of judgment time periods may be after ten seconds, after one hour, after one day and after one week.

In step S203, the mobile device 1 determines whether a target time period, indicated by the set instruction, in the plurality of judgment time periods is identical to the preset time period. Specifically, when the target time period is identical to the preset time period, the mobile device 1 performs step S205, and when the target time period is different from the preset time period, the mobile device 1 performs step S207.

In step S205, the mobile device 1 does not change the preset time period. Specifically, when the target time period is identical to the preset time period, the mobile device 1 does not change the preset time period and continues to perform step S103 in FIG. 2, which is waiting for the original preset time period.

In step S207, the mobile device 1 replaces the preset time period with the target time period. Specifically, when the target time period is different from the preset time period, the mobile device 1 replaces the preset time period with the target time period and continues to perform step S103 in FIG. 2, which is waiting for the target time period.

As shown in FIG. 4, step S107 in FIG. 2 may comprise step S301: receiving the set instruction in response to the reminder message; step S303: determining whether the set instruction indicates a close notification option; when the set instruction does not indicate the close notification option, performing step S305: not changing the preset time period; and when the set instruction indicates the close notification option, performing step S307: not changing the preset time period and stopping determining whether the smart key is connected to the mobile device via the Bluetooth or setting the preset time period to infinite.

In step S301, the mobile device 1 receive the set instruction in response to the reminder message. Specifically, the set instruction received by the mobile device 1 is in response to the reminder message, wherein the reminder message may further comprise the close notification option.

In step S303, the mobile device 1 determines whether the set instruction indicates the close notification option. Specifically, when the set instruction does not indicate the close notification option, the mobile device 1 performs step S305, and when determining that the set instruction indicates the close notification option, the mobile device 1 performs step S307.

In step S305, the mobile device 1 does not change the preset time period. Specifically, when the set instruction does not indicate the close notification option, the mobile device 1 does not change the preset time period and continues to perform step S103 in FIG. 2, which is waiting for the original preset time period.

In step S307, the mobile device 1 does not change the preset time period and stops determining whether the smart key is connected to the mobile device via the Bluetooth, or setting the preset time period to infinite. Specifically, when determining that the set instruction indicates the close notification option, the mobile device 1 does not perform step S103 in FIG. 2, which is waiting for the original preset time period and does not perform the determination of step S101, or setting the preset time period to infinite. That is, the function of determining whether the Bluetooth connection exists between the mobile device 1 and the smart key 2 is shut down.

In yet another embodiment, the set instruction received by the mobile device 1 is in response to the reminder message, wherein the reminder message may comprise a plurality of options corresponding to a plurality of judgment time periods respectively and the close notification option. When the mobile device 1 determines that the set instruction indicates one of the plurality of options for the plurality of judgment time periods, the mobile device 1 performs the aforementioned step S203 and performs step S205 or S207 according to the result of the determination in step S203. And when the mobile device 1 determines that the set instruction indicates the close notification option, the mobile device 1 performs the aforementioned step S307. In this way, the user may select the plurality of options to change the preset time period to postpone receiving the reminders or select the close notification option to turn off all the reminders. The embodiment may be adapted to a variety of situations the users may face, such as when the key is quickly available, when it takes a while to get the key, when the key is temporarily on loan, when the car or key takes longer to be repaired, or when the key is not used for a long time.

Please refer to FIG. 5 along with FIG. 1 and FIG. 2, wherein FIG. 5 is a flowchart illustrating the step of close notification option a lost reminder method of a smart key according to yet another embodiment of the disclosure. As shown in FIG. 5, in addition to steps S101 to S107 shown in FIG. 2, the lost reminder method of the smart key further comprises step S401: providing a closing option; and step S403: in response to a trigger instruction of the closing option, stopping determining whether the smart key is connected to the mobile device via the Bluetooth. The step of closing option may be applied to the schematic diagram of the operating environment for the lost reminder method of the smart key shown in FIG. 1. The closing option shown in FIG. 5 is exemplarily illustrated in the following descriptions with the mobile device 1 shown in FIG. 1.

In step S401, the mobile device 1 provides a closing option. Specifically, the closing option is used to shut down the determination of whether the mobile device 1 and the smart key 2 are connected via the Bluetooth.

In step S403, the mobile device 1 responds to a trigger instruction of the closing option by stopping determining whether the smart key is connected to the mobile device via the Bluetooth. Specifically, after the closing option is triggered, the mobile device 1 responds to the trigger instruction of the closing option and stops determining whether the mobile device 1 and the smart key 2 are connected via the Bluetooth.

In this embodiment, step S401 and step S403 may be performed during the execution of any step between step S101 and step S107.

The lost reminder method of the smart key described in the embodiments above may be stored as an application program (APP) on the mobile device 1. Additionally, in some embodiments, the lost reminder method of the smart key described in the embodiments above may be comprised in non-transitory computer readable medium in the form of at least one computer executable program, such as CD-ROM, USB flash drive, memory card, hard drive of a cloud server, etc. When the at least one computer executable program is executed by a computer processor, the lost reminder method of the smart key described in the previous embodiment are implemented.

In view of the above description, the disclosure of the lost reminder method of the smart key and the non-transitory computer readable medium storing computer executable program corresponding to the method may provide the user with a reminder immediately after losing the smart key, and may be used to retrieve the smart key within a smaller range and with a less time shift, thus improving the problem of time and money spent on reconfiguration when losing the smart key. Additionally, through the reminder message comprising the geographic information of the time point of determining that the smart key is not connected to the mobile device via the Bluetooth, the lost reminder method of the smart key disclosed by some embodiments of the present invention may provide the full location details to ensure that, the smart key may still be retrieved in within a smaller range and with less time shift even if the user does not receive the reminder message immediately.

Although the present invention is disclosed in the foregoing embodiments, it is not intended to limit the present invention. Change and modifications made without departing from the spirit and scope of the present invention belong to the scope of the present invention. For the protection scope defined by the present invention, please refer to the attached claims.

What is claimed is:

1. A lost reminder method of a smart key, performed by a mobile device, comprising:
periodically determining whether the smart key is connected to the mobile device via Bluetooth using a preset time period;
outputting a reminder message when the smart key is not connected to the mobile device via the Bluetooth; and
selectively updating the preset time period according to a set instruction in response to the reminder message.

2. The lost reminder method of the smart key of claim 1, wherein the reminder message comprises a plurality of options corresponding to a plurality of judgment time periods respectively and selectively updating the preset time period according to the set instruction in response to the reminder message comprises:
determining that the set instruction indicates a target time period in the plurality of judgment time periods;
replacing the preset time period with the target time period when the target time period is different from the preset time period; and
not changing the preset time period when the target time period is identical to the preset time period.

3. The lost reminder method of the smart key of claim 1, wherein the reminder message comprises a close notification option and selectively updating the preset time period according to the set instruction in response to the reminder message comprises:
not changing the preset time period and stopping determining whether the smart key is connected to the mobile device via the Bluetooth when the set instruction indicates the close notification option; or
setting the preset time period to infinite when the set instruction indicates the close notification option.

4. The lost reminder method of the smart key of claim 1, wherein the reminder message comprises geographic information corresponding to a time point when it is determined that the smart key is not connected to the mobile device via the Bluetooth.

5. The lost reminder method of the smart key of claim 1, further comprising:
not outputting the reminder message when the smart key is connected to the mobile device via the Bluetooth.

6. The lost reminder method of the smart key of claim 5, further comprising:
outputting a strength message corresponding to Bluetooth signal strength when the smart key is connected to the mobile device via the Bluetooth.

7. The lost reminder method of the smart key of claim 1, further comprising:
providing a closing option; and
in response to a trigger instruction of the closing option, stopping determining whether the smart key is connected to the mobile device via the Bluetooth.

8. The lost reminder method of the smart key of claim 1, wherein the reminder message comprises a text pop-up window.

9. The lost reminder method of the smart key of claim 8, wherein the reminder message further comprises at least one of a voice signal and a vibration signal.

10. A non-transitory computer readable medium, comprising at least one computer executable program, with the at least one computer executable program being executed by a processor to carry out the lost reminder method of the smart key of claim 1.

11. A non-transitory computer readable medium, comprising at least one computer executable program, with the at least one computer executable program being executed by a processor to carry out the lost reminder method of the smart key of claim 2.

12. A non-transitory computer readable medium, comprising at least one computer executable program, with the at least one computer executable program being executed by a processor to carry out the lost reminder method of the smart key of claim 3.

13. A non-transitory computer readable medium, comprising at least one computer executable program, the at least one computer executable program being executed by a processor to carry out the lost reminder method of the smart key of claim 4.

14. A non-transitory computer readable medium, comprising at least one computer executable program, with the at least one computer executable program being executed by a processor to carry out the lost reminder method of the smart key of claim 5.

15. A non-transitory computer readable medium, comprising at least one computer executable program, with the at least one computer executable program being executed by a processor to carry out the lost reminder method of the smart key of claim 6.

16. A non-transitory computer readable medium, comprising at least one computer executable program, with the at least one computer executable program being executed by a processor to carry out the lost reminder method of the smart key of claim 7.

17. A non-transitory computer readable medium, comprising at least one computer executable program, with the at least one computer executable program being executed by a processor to carry out the lost reminder method of the smart key of claim 8.

18. A non-transitory computer readable medium, comprising at least one computer executable program, with the at least one computer executable program being executed by a processor to carry out the lost reminder method of the smart key of claim 9.
